(19) United States
(12) Patent Application Publication
(10) Pub. No.: US 2012/0000949 A1
(43) Pub. Date: Jan. 5, 2012

(54) COMBINATION GUN RACK AND GUN CASE

(76) Inventor: Ambers F. Williams, JR., Fayetteville, TN (US)

(21) Appl. No.: 13/171,543

(22) Filed: Jun. 29, 2011

Related U.S. Application Data
(60) Provisional application No. 61/360,267, filed on Jun. 30, 2010.

(51) Int. Cl. B60R 9/02

(52) U.S. Cl. 224/401

(57) ABSTRACT

A case for transporting hunting equipment on an all terrain vehicle or similar vehicles is described. The case has a cover that pivots about a bottom shell and provides easy access to the hunting equipment by a hunter sitting on the seat of the all terrain vehicle. The case and a mount in the case protect hunting equipment from weather and travel over rough terrain. The case can be mounted on the left side or the right side of the all terrain vehicle or on other places on similar vehicles.

### CROSS-REFERENCE TO RELATED APPLICATIONS

This application is related to U.S. Pat. No. 6,793,108, entitled “Pivoting Assembly for Holding a Gun or a Bow” issued on Sep. 21, 2004, which is incorporated herein by reference. This application claims priority to U.S. Provisional Application No. 61/360,267, entitled “Combination Gun Rack and Gun Case,” and filed on Jun. 30, 2010, which is incorporated herein by reference.

### FIELD OF THE INVENTION

The present invention relates to attaching an adjustable mounting assembly and case to an All Terrain Vehicle (“ATV”) where the mounting assembly may hold a gun or a bow. The mounting assembly and case are integrated to form a unit in order to allow a gun or bow to fit closely to the contour of the ATV or other vehicle, thereby providing a compact profile suitable for traveling in areas with dense undergrowth and other conditions that would be hazardous to the gun or bow.

### BACKGROUND OF THE DISCLOSURE

All terrain vehicles (ATVs) and similar vehicles have become a popular and useful means for transportation in areas not suitable for cars and trucks. Sportsmen, hunters, and others use ATVs for carrying camping, hunting, or other equipment. Because ATVs are not suitable for attachment of a standard gun rack or other conventional hunting equipment brackets there is a need for providing a way for hunters and sportsmen to mount and secure their weapons of choice, gun or bow, to ATVs (also known as “four wheelers”). Although ATVs normally provide accessory packages which

include rack extension kits or “baskets”, the user is typically left with the problem of securing guns, bows and various shaped devices securely to the ATV in a way that reduces the chance of the user's hunting equipment from falling or being knocked loose. This is especially important when an ATV travels on rough terrain having dense undergrowth, vegetation or other obstacles that may knock equipment loose or damage equipment. Hence ATV transported hunting equipment should be mounted securely and fit closely to the contour of the ATV. In addition, a cover is often needed for a gun to protect the gun from rain, wind, dust, snow and other environmental conditions.

### BRIEF DESCRIPTION OF THE DRAWINGS

The disclosure can be better understood with reference to the following drawings.

The elements of the drawings are not necessarily to scale relative to each other, emphasis instead being placed upon clearly illustrating the principles of the disclosure. Furthermore, like reference numerals designate corresponding parts throughout the several views.

FIG. 1 depicts a conventional hunting equipment boot case attached to an all terrain vehicle.

FIG. 2 depicts an embodiment of a hunting equipment case in accordance with the present disclosure attached to an all terrain vehicle.

FIG. 3 is a top view of the embodiment of FIG. 2 depicting the orientation of the hunting equipment case with respect to the all terrain vehicle.

FIG. 4A, 4B, 4C depict an embodiment of a hunting equipment case in accordance with the present disclosure.

FIG. 5 is a cross-sectional view of the embodiment of FIG. 4 with the cover open.

FIG. 6 depicts a cross-sectional view of an embodiment of a hunting equipment case in accordance with the present disclosure.

FIG. 7 depicts the case of FIG. 6 with the cover open.

FIG. 8 depicts an embodiment of a case in accordance with the present disclosure.

FIG. 9 depicts an embodiment of a support assembly in accordance with the present disclosure.

FIG. 10 depicts an embodiment of a support assembly in accordance with the present disclosure.

FIG. 11 depicts an embodiment of a support assembly in accordance with the present disclosure.

### DETAILED DESCRIPTION

Hunters often transport various kinds of hunting equipment on an all terrain vehicle (ATV) 10. Under many transport circumstances, it is desirable and/or necessary to protect the hunting equipment from exposure to hazardous conditions. Such transport conditions include weather, road, and terrain conditions wherein the hunting equipment may be damaged, misalignment or otherwise harmed if the hunting equipment is not protected. In order to protect a piece of hunting equipment, including, for example, a rifle, a bow, or a pistol, a protective case is used to protect the hunting equipment. For example, a hunting rifle is often placed within a hard shell case, sometimes called a boot case, to reduce the chance of damage. A conventional hard shell case is an enclosure having a shaped cavity to receive the hunting rifle. Within the shaped cavity, there are usually layers of shock resistant absorbing foam or other cushioning material that prevent the hunting rifle from moving about within the boot case, thereby reducing the chance a rifle will get damaged during transport. An example of a conventional protective case, a boot case 20 is depicted in FIG. 1. Such a boot case 20 is available, for example, from the Koplin Company of Fox Lake, Wis. and is sold at sporting goods stores. The boot case 20 is made of hard plastic that forms the shaped cavity for holding the rifle. The boot case 20 has a top shell hinged to a bottom shell and a latch for holding the case in a closed position. After a rifle is placed in an opened boot case 20, the case is closed and latched. A hunter carries the boot case by grasping a handle (not shown) on the boot case. If the hunter wants to transport the hunting rifle within the boot case 20 on an ATV 10, the boot case 20 is slipped into a sleeve 24 mounted on the ATV 10 next to the seat 12 of the ATV. Although the sleeve 24 that holds the boot case 20 is usually dimensioned for receiving a particular boot case, the sleeve 24 may also be used for securing other items to the ATV 10. The sleeve 24 has a retaining latch that can be tightened in order to securely hold the boot case 20 within the sleeve. The sleeve 24 is attached to the ATV 100 using bolts, screws or other attachment devices. The boot case 20 and sleeve 24 arrangement provide good protection for transporting a rifle or other hunting equipment on the ATV 10.

However, the boot case 20 and sleeve 24 rifle carrying arrangement has some shortcomings. Often, during the transport of a rifle within the boot case 20 within the latched sleeve 24 on the ATV 10, a hunter may desire quick access to the rifle. In order to remove the rifle from the boot case 20, the hunter must stop the ATV, get off the ATV, unlatch the sleeve latch and slide the boot case 24 from the sleeve 24. Next, the hunter must unlatch and open the boot case 20. After the boot case 20 is opened, the hunter then retrieves the rifle. Although the rifle is somewhat protected using the boot case 20, the rifle sometimes is thrown about within the case causing damage or misalignment to the rifle because of insufficient padding and/or the shape of the case's cavity. Further, an undesirable amount time is required to remove to the rifle from the boot case. In addition, when the hunter desires to remount the boot case with the rifle on the ATV 10, the time consuming process is reversed. There is a need to reduce the time delay associated with retrieving a rifle using a conventional sleeve mounted boot case 20. Another way that hunters protect a rifle during transport is to put the rifle in a soft protective case with a zipper opening, and then securing the soft case to the ATV 10 with one or more straps. The soft case usually provides good protection for the rifle, but the protection level is generally less than that of the boot case 20. In addition, the soft case does not allow for quick access. Hence, there is a need for a transport system that protects hunting equipment, but makes the equipment easily accessible to the hunter.

The hunting equipment case of the present disclosure, described for holding a rifle, overcomes shortcomings associated with conventional cases. The case of the present disclosure has a cover that is pivotally mounted, for example with hinges, to a bottom shell. Within the bottom shell are mounts that extend upward and are shaped for holding a rifle. In addition, the case has a quick-release latch that reduces the time required for the hunter to retrieve the rifle. When the latch of the case is unlatched by the hunter, the hunter then pivots the cover about the hinges and pulls the rifle from the mounts. The rifle is protected during transport and is easily retrieved by the hunter. The procedure for placing the rifle back within the case, after a retrieval of the rifle, comprises placing the rifle in the mounts, swinging the cover closed, and latching the quick-release latch.

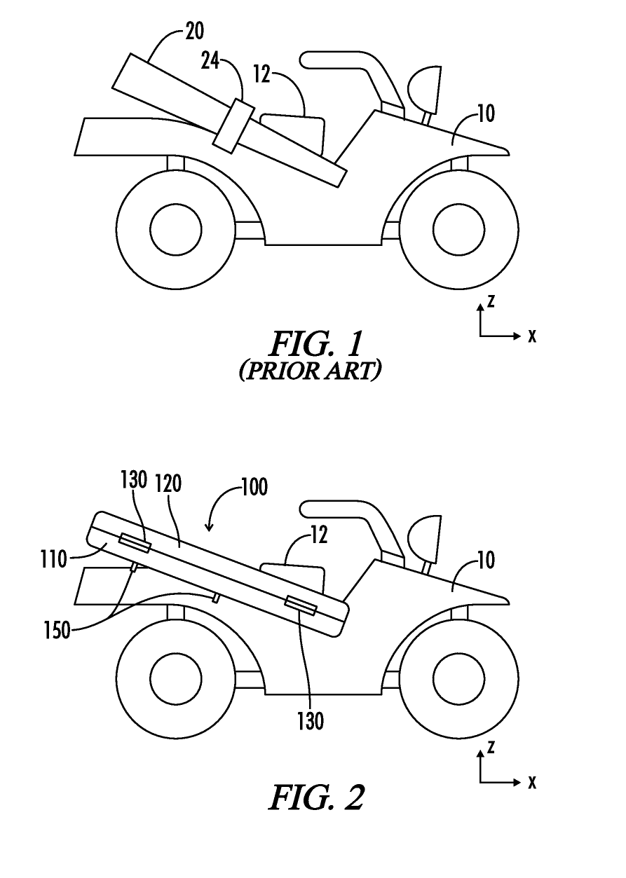

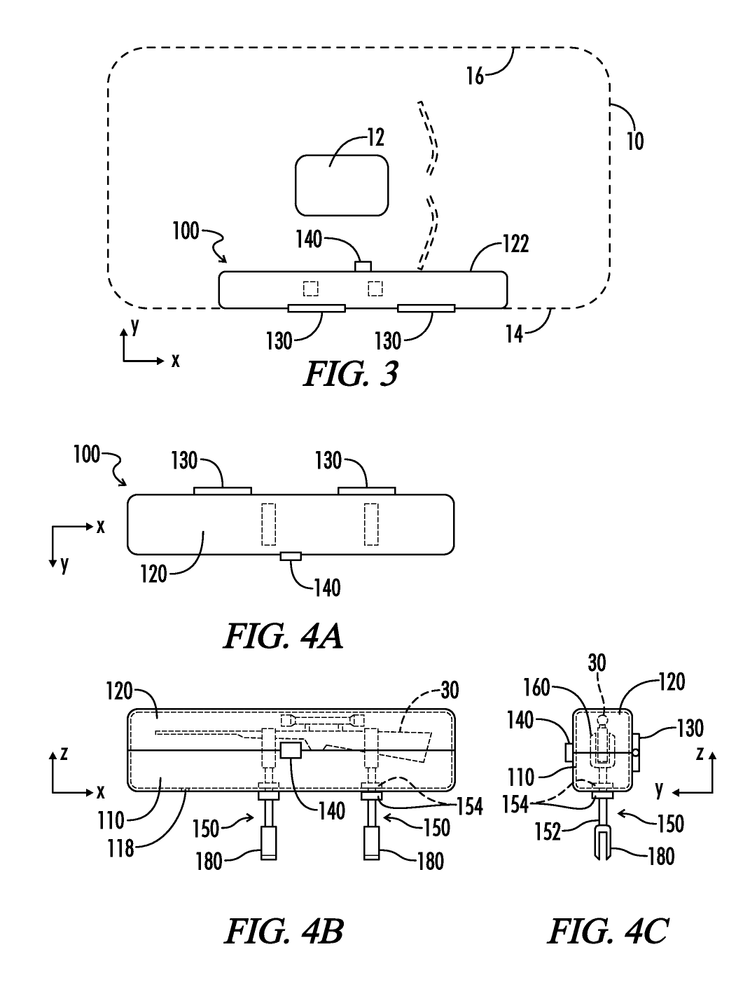

FIG. 2 depicts an embodiment of a hunting case 100 in accordance with the present disclosure. The case 100, as depicted, is coupled to the ATV 10 by support assemblies 150. The case 100 has a bottom shell 110 pivotally coupled to a cover 120 with one or more hinges 130. The case 100 is mounted, from an ATV driver's perspective, on the right side 14 of the ATV 10, as shown in FIG. 3. The right side 14 and the left side 16 of the ATV 10 correspond to a respective side as viewed by a rider facing forward (the x-direction) and sitting on the seat 12 of the ATV 10. When the case 100 is opened, the cover 120 extends outward (the negative y-direction) from the seat 12 of the ATV 10. The side of the case 100

that is facing inward (the y-direction) towards the seat 12, has a quick release latch 140 that allows a hunter to easily open the case 100 for access to hunting equipment, such as a rifle. In some circumstances it may be desirable to mount the case 100 on the left side 16 of the ATV 10. When the case 100 is mounted on the left side 16 of the ATV 10, the latch 140 of the case 100 is adjacent to, i.e. near to, the seat 12 of the ATV 10 and the hinges 130 extend outward (the y-direction) from the ATV. Although the exemplary embodiments of the disclosure depict the case 100 mounted on an ATV, in other embodiments it is possible to mount the case on a utility terrain vehicle (UTV), a bad boy buggy or other vehicle used by hunters and outdoorsman.

Embodiments of the present disclosure generally pertain to a combination of a gun rack and a gun case. In one embodiment, the gun rack of U.S. Pat. No. 6,793,108 is combined with an enclosure having a cavity for holding a rifle, pistol, bow or other hunting equipment in order to protect such hunting equipment from the rain, dust, snow or other hazards. The case 100 may be made or a variety of materials that are for all intents and purposes water and dust proof. Such materials, for example, may be metal, plastic, fiber glass, other fibrous materials, composite materials, combinations of materials and other materials that may be or are used for protecting hunting equipment or other equipment. When the enclosure of case is made of plastic the enclosure may be fabricated using a variety of known techniques, such as, spin casting, die casting or injection molding.

An embodiment of case 100 in accordance with the present disclosure is depicted in FIG. 4. A top view of the case 100 depicted in FIG. 4A comprises a cover 120, a bottom shell 110 (best seen in front view FIG. 4B) and hinges 130 for pivotally coupling the cover 120 to the bottom shell 110. Although two hinges 130 are shown, in other embodiments fewer or more hinges are possible. The hinges 130 are attached to the cover 120 and the bottom shell 110 using well known fasteners, including, for

example, screws, bolts, rivets or adhesives. The number of hinges, sizes of the hinges, and characteristics of the hinges are not a limitation of the present disclosure. The hinges 130 allow the cover 120 to pivot about the bottom shell 100 thereby forming an enclosure with an opened position and a closed position. When the enclosure is in the opened position a rifle may be removed from or placed into the cavity of the enclosure. A rifle within the cavity of the enclosure is protected when the enclosure is in the closed position. The size and shape of the cover 120 and the bottom shell 110 are selected, in part, to provide a protective enclosure with cavity for a holding a piece of hunting equipment. The bottom shell 110 has one or more holes 118 on a lower surface 111 of the bottom shell 110 where each hole is available for attachment of a support assembly 150. If hole 118 is not used for attaching a support assembly 150, a snap plug 119 is pushed into the hole for preventing undesirable material from entering the cavity of the enclosure. Each support assembly 150 has a mount 160 for securely holding all or a portion of a piece of hunting equipment. For example, if the hunting equipment 30 is a rifle, one mount 160 holds or grips the butt end of the rifle and another mount 160 grips another portion of the rifle. The support assembly 150 is attached, as depicted in FIG. 4, to the bottom shell 110 by sandwiching material from a bottom wall 111 of the bottom shell 120 between two nuts 154 that are on a threaded portion 156 of a support shaft 152 of the support assembly 150. The bottom portion of the support shaft has a coupler 180, such as a U-shaped clamp, as depicted in FIG. 4C. The coupler 180 fits about a bar or rod on the ATV 10 and is securely fastened thereto using a bolt or other known fastener. In other embodiments other types of couplers are possible. For example, the coupler may have a foot for mounting the support assembly 150 to a flat surface of the ATV 10. The couplers of the holding assembly described in U.S. Pat. No. 6,793,108, incorporated herein by reference, may also be used as couplers for embodiments of the present disclosure. For the embodiment of the present disclosure as depicted in FIG. 4, both the cover 120 and the bottom shell have a trough shape. The bottom shell 110 has a bottom wall, longitudinal walls, and end walls that form an open container. The cover 120 has a top wall, two longitudinal walls, and two end walls. When the cover edges are engaged with the bottom shell edges the case 100 is in closed position. When the case 100 is in the closed position and a latch 140 is latched the contents within the cavity of the enclosure are protected from natural and other environmental hazards that may be harmful to hunting equipment.

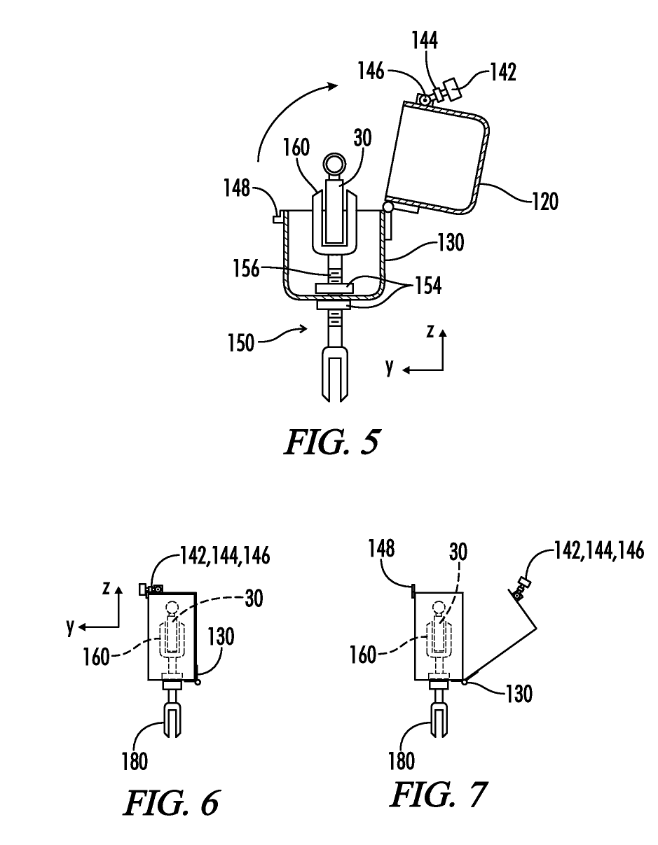

Another embodiment of case 100 of the present disclosure is depicted in FIG. 5.

In FIG. 5, the case 100 is shown as a side view wherein the case 100 partially opened. When the cover 120 rotates 180 degrees in the clockwise direction from the closed position, the back wall of the cover, the wall attached the hinge, is vertically oriented (in the z-direction). In some embodiments the amount of rotation clockwise is limited by functional characteristics of the hinges 130 or by the allowable rotation provided the back walls of the cover and bottom shell. In one embodiment the amount of rotation of the cover 120 is between 110 degrees and 140 degrees where 0 degrees represents the closed position of the cover 120. In one embodiment, the latch 140 comprises a catch tab 148 that holds a catch ring 144 in a slot of the catch tab when the latch is latched, i.e., closed. The catch ring 144 is positioned within the catch tab 148 when the pull handle 142 stretches the elastic material of the arm of the latch 140 as the arm rotates about pivot pin 146. The latch 140 is a well known latch that is often referred to as a hood latch because it is often used to hold the hood of a car or truck closed. In other embodiments other latches are possible.

Hunting equipment, such as a rifle, is protected within the cavity of the case 100 when the case is in the closed position. In order to remove the rifle, latch 140 is unlatched by grasping the pull handle 142 and rotating the arm of the latch away from the catch tab 148. Once the latch 140 is unlatched, cover 120 is rotated away from the

catch tab, a clockwise direction as depicted in FIG. 5, by at least 100 degrees. Other angles of rotation are possible in other embodiments. However, in general, the amount of rotation has a value that allows easy access to the rifle and is sufficient so that case stays in the opened position until it is desired that the case be closed. In embodiments where the cover 120 rotation angle is not at least 90 degrees there may be some difficulty retrieving the hunting equipment. If the cover angle is too great, such as around 180 degrees, then the hunter would have to reach further to grasp the pull handle 142 of the latch 140 for closing the case 100. The mount 160 on the top (the z-direction) of the support assembly 150 has a U-shape. Within the “U” is a resilient pad that may be one of a variety of materials known to those in the art. The resilient pad squeezes and secures the hunting equipment within the mount 160. In other embodiments other materials and techniques for gripping and securing the hunting equipment within the mount 160 are possible. For other embodiments a strap 162, shown in FIG. 10, extends across the top of the U-shape to further secure the hunting equipment within the mount 160. The strap 162 is depicted as a elastic strap, such as a rubber strap, attached to ears or pins on each side of the mount by holes in the strap. In other embodiments other straps attachment techniques are possible.

FIG. 6 depicts an embodiment of case 100 wherein the bottom shell 110 is L-shaped and the cover 120 is L-shaped as seen in the side view. The bottom shell 110 also has end walls so that the case 100 forms an enclosure with a cavity when the case 100 is in a closed position. If the walls of the bottom shell or top shell are thin, then supports ribs are added to provide a desired amount of rigidity. The embodiment having the L-shaped elements is shown in the closed position in FIG. 6 and the opened position in FIG. 7.

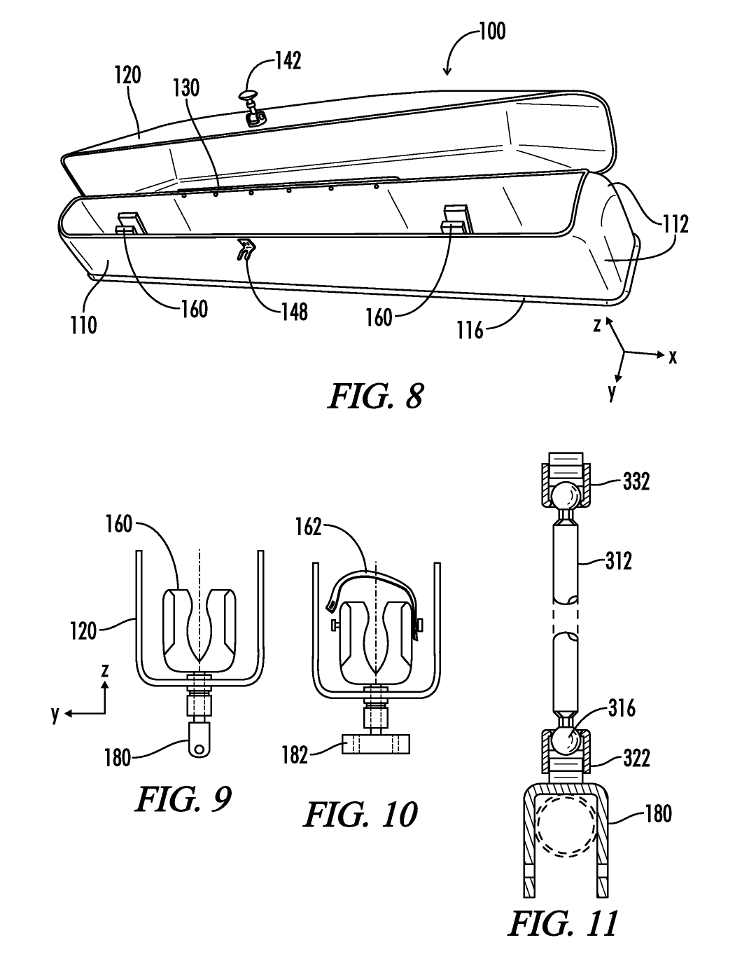

Another embodiment of the present disclosure is depicted in FIG. 8 where case 100 is in an opened position. The embodiment of FIG. 8 depicts case 100 having a cover 120 with a flat top wall, parallel front and back walls and tapered end walls. The bottom shell 110 has a flat bottom wall, parallel front and back walls and rounded end walls 112. Push-on trim 116 is shown going around lower portion of the bottom shell 110. In other embodiments push-on trim 116 is placed on other portions of the case 100. The mounts 160 are shown extending upward from the bottom wall of the shell 120. The locations of the mounts 160 are shown to be near each of the end walls of the bottom shell 110. In other embodiments other locations are possible. Other locations are also desirable because the hunting equipment has a variety of sizes. The support assembly 150 uses a threaded shaft portion 156 with nuts 154 for attachment to material of the bottom wall of the bottom shell so that position changes are made by moving the support assembly to a hole at a desired location.

The case 100 of the present disclosure provides environmental protection of hunting equipment by securely holding the hunting equipment within the cavity of a protective enclosure. The case 100 easily opens for access to the hunting equipment by unlatching the latch 140 and swinging the cover 120 about the hinges 140. The protective enclosure is attached to the ATV 10 either on the left side or the right side of the ATV 10 as desired by the user. There are a variety of couplers for attaching the case 100 to the ATV 10. In that regard, the couplers use attachment techniques that are dependent on mounting sites available for a particular ATV 10. The support assembly 150 has an attachment end with a coupler for coupling, i.e., attaching, the support assembly 150 and the enclosure of the case 100 to the ATV 10.

FIGS. 9, 10 and 11 show embodiments of the support assembly 150. FIG. 9 depicts an embodiment of support assembly 150 wherein the support structure is coupled to material of the bottom wall of the bottom shell 120 with two nuts 154. The attachment end of the support assembly is a U-shaped clamp with holes for insertion of a bolt. The U-shaped clamp fits about a mounting bar (not shown) of the ATV. The embodiment attachment technique depicted in FIG. 10 shows a foot with two mounting holes on the attachment end of the support structure 150. Also shown in FIG. 11 is a strap 162 that stretches over the mount 160 of the support assembly 105 to press hunting equipment snuggly within the mount. The strap may be coupled to the sides of the mount by pushing the ends of the strap 162 over attachment pins. In other embodiments other attachment techniques are possible, such as, for example, Velcro™ straps looped through slots. FIG. 11 depicts a mounting structure 150 that has a movable shaft 312. A ball 316 and coupling nut provide the function of the movable shaft. Details of the mounting structure of FIG. 11 are described more fully in U.S. Pat. No. 6,793,108, entitled “Pivoting Assembly for Holding a Gun or a Bow” issued on Sep. 21, 2004, which is incorporated herein by reference.

It should be emphasized that the above-described embodiments of the present disclosures are merely possible examples of implementations set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and protected by the following claims.

1. A case for transporting hunting equipment on a vehicle, comprising:
an enclosure having a cavity, the enclosure comprising a bottom shell and a cover, wherein the cover is pivotally mounted to the bottom shell;
one or more mounts attached to the bottom shell, the mounts shaped for holding hunting equipment within the cavity of the enclosure; and
a coupler attached to each of the mounts for coupling the case to the vehicle.

2. The case of claim 1, wherein a latch holds the bottom shell to the cover.

3. The case of claim 2, wherein the mount is U-shaped and has resilient material that contacts a portion of the hunting equipment.

4. The case of claim 1 wherein the material of the bottom shell and the cover are made of plastic.

5. The case of claim 1, wherein the coupler is attached to the bottom wall of the bottom shell.

6. The case of claim 6, wherein the coupler is attached to a wall of the bottom shell with nuts on a threaded portion of a shaft extending between the mount to the coupler.

7. A system for providing protection to hunting equipment transported by a vehicle:
two or more support assemblies, wherein each support assembly has a mount for holding the hunting equipment and a coupler for coupling the support assembly to the vehicle; and
an enclosure coupled to the support assemblies, the enclosure comprising a bottom shell pivotally mounted to a cover, wherein the enclosure has a cavity that encloses the mounts when the enclosure is in an closed position.

8. The mounting system of claim 7, wherein a latch holds the enclosure in a closed position.

9. The mounting system of claim 8, wherein the latch comprises a pull handle with a catch ring and a catch tab.

10. The mounting system of claim 7 wherein the pivot mounting is one or more hinges.

11. The mounting system of claim 7, wherein the coupler is U-shaped coupler and has a bolt extending through a hole in the “U” for squeezing the U about an attachment bar on the vehicle.

12. The mounting system of claim 7, wherein the coupler has a foot with holes for attaching the support assembly to the vehicle.

13. The mounting system of claim 7, wherein the mount is U-shaped and lined with a resilient material.

14. The mounting system of claim 13, wherein the mount has a strap that extends across the top of the mount to hold the hunting equipment within the mount.

15. A case for protecting hunting equipment transported by a vehicle comprising:
an enclosure comprising a bottom shell with an edge hinged to one edge of a cover, wherein the cover and bottom shell further have a latch connected to another edge of the cover and to an another edge of the bottom shell, so that the enclosure provides a protective cavity for the hunting equipment; and
at least one support arm extending through and coupled to the bottom shell, wherein each respective support arm has a mount on one end for holding hunting equipment and a coupler on the other end for coupling the support arm to the vehicle.

16. The case of claim 15, wherein a latch holds the bottom shell to the cover when the case is in a closed position.

17. The case of claim 16, wherein the cover pivots about the bottom shell when the latch is unlatched.

18. The case of claim 15, wherein the mount is U-shaped and has resilient material that grasps a portion of the hunting equipment.

19. The case of claim 15, wherein the material of the bottom shell and the cover are made of plastic.

20. The case of claim 15, wherein the bottom shell has multiple holes that provide for changing the location of support arms.
